(19) United States
(12) Patent Application Publication
(10) Pub. No.: US 2021/0089370 A1
(43) Pub. Date: Mar. 25, 2021

(54) EVENT MANAGEMENT IMPACT BASED ON INPUTS

(71) Applicant: ServiceNow, Inc., Santa Clara, CA (US)

(72) Inventors: Vadim Dukhovny, Petah-Tikva (IL); Yair Leibkowiz, Lod (IL)

(21) Appl. No.: 16/582,773

(22) Filed: Sep. 25, 2019

(51) Int. Cl. G06F 9/54; G06F 11/32; G06F 9/50

(52) U.S. Cl. CPC G06F 9/542; G06F 9/5072; G06F 9/5033; G06F 11/327

(57) ABSTRACT

In accordance with aspects of the present approach, event management systems and methods are described. In accordance with certain of these implementations, information about alerts may include whether a given alert has been acknowledged or not acknowledged, where acknowledged alerts may not have a current action to be taken, but remain open. In certain aspects, acknowledged alerts may be filtered out or otherwise removed from certain displays or presentations, allowing alerts that are not acknowledged, but otherwise of lower priority, to be more readily viewed. More generally, the capability to improve the visibility lower priority alerts may be improved in other contexts, instead of or in addition to the status of the “Acknowledged” alert field, such as based on values in other alert fields.

### BACKGROUND

The present disclosure relates generally to management and prioritization of notifications, such as in an IT operations management (ITOM) context.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

However, a consequence of the increasing complexity and interrelatedness of such computer and network-based resources, such as cloud-based resources, is that it is increasingly different to monitor and manage event and alerts present within the computerized environment. For example, it may be difficult to view or manage alerts that affect the platform or systems being monitored and in some instances alerts may not be seen or may be otherwise missed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with aspects of the present approach, event management systems and methods are described herein. In accordance with certain of these implementations, information about alerts may include whether a given alert has been acknowledged or not acknowledged, where acknowledged alerts may not have a current action to be taken, but remain open. In certain aspects, acknowledged alerts may be filtered out or otherwise removed from certain displays or presentations, allowing alerts that are not acknowledged, but otherwise of lower priority, to be more readily viewed. Though use of an “acknowledged” alert status is used herein by way of example, and to provide a useful real-world context, the present approach may also be employed based on other alert fields in addition to or in the alternative of an “acknowledged” field as discussed herein. For example, the capability to improve the visibility of lower priority alerts may be improved using the techniques described herein applied to other alert fields in addition to or instead of an acknowledged alert status field.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 depicts an example of a process flow by which one or more alert records may be changed to have an acknowledged status, in accordance with aspects of the present disclosure;

FIG. 6 depicts an example of a process flow by which viewing of acknowledged alerts is toggled on or off, in accordance with aspects of the present disclosure;

FIG. 7 depicts an example of an interface listing alert records having an acknowledged status field and an interface for changing the acknowledged status of an alert record, in accordance with aspects of the present disclosure;

FIG. 8 depicts an example of an event management dashboard including a control feature to ignore acknowledged alerts, in accordance with aspects of the present disclosure;

FIG. 9 depicts the dashboard of FIG. 8 in which the control feature is activated to ignore acknowledged alerts, in accordance with aspects of the present disclosure;

FIG. 10 depicts an example of a dashboard having a map feature and including a control feature to ignore acknowledged alerts, in accordance with aspects of the present disclosure;

FIG. 11 depicts the dashboard of FIG. 10 in which the control feature is activated to ignore acknowledged alerts, in accordance with aspects of the present disclosure; and

FIG. 12 depicts an impact tree map view incorporating correlated alert information, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As discussed herein, personnel involved in the management or oversight of an IT operation may rely on various tools to monitor to facilitate their tasks. For example, a network operations center (NOC) operator may monitor or view a dashboard on a graphical user interface (GUI) in which the dashboard displays a current or up to date view of the status of monitored components and/or services. For example, such a dashboard, e.g., an event management (EM) dashboard, may display some or all of the current outstanding alerts affecting the components or services being monitored. Due to the complexity and/or scale of many such systems, however, a NOC operator may miss relevant or important alerts (or other events) that are prioritized below or otherwise obscured by higher level or more critical events.

Such missed alerts, since they are not visible to the NOC operator, may not be addressed (i.e., handled), even though they could be, even in contexts where the obscuring or more critical alerts may already have been seen or may be in a state of being addressed, i.e., acknowledged. For example, a high severity or critical alert taking precedence on an EM dashboard may relate to a router not functioning. The alert may stay on the dashboard as a critical or high severity alert even after corrective action has been taken (e.g., a replacement router has been ordered but has not yet arrived or been installed). In such a case, such an alert has been addressed by the NOC operators, but may still obscure or de-emphasize other alerts that do not have lower criticality but otherwise need attention.

In accordance with the present approach, alerts may be assigned an “acknowledged” status while still pending (i.e., not closed out or finally addressed) but for which corrective action has been initiated and no present action is needed (e.g., a part is awaiting delivery, software fix is being coded or debugged, and so forth). Alerts having an acknowledged status may be hidden, ignored, or otherwise removed or de-emphasized from alert displays and/or listings or other alert-based impact calculations due to corrective action already having been initiated. In accordance with this approach, the operator's actions with respect to an alert may be reflected in the status of the alert as acknowledged and this in turn may be taken into consideration to more precisely calculate impact for the alert.

Further, the operator therefore has more tools and control on how to view the health or status of systems and/or services being monitored due to the ability to indicate that an alert has been acknowledged or addressed, even if that alert is still pending (i.e., is not finally resolved). Further, an operator will be less likely to miss other alerts (e.g., less severe or same severity alerts) due to the ability to mask or remove acknowledged alerts from a dashboard or other overview-type presentation (e.g., a service map screen, and so forth), helping to ensure all alerts are handled. Though use of an “acknowledged” alert status and field is used herein by way of example, and to provide a useful real-world context, the present approach may also be employed based on other alert fields in addition to or in the alternative of an “acknowledged” field as discussed herein. For example, the capability to improve the visibility of lower priority alerts may be improved using the techniques described herein applied to other alert fields in addition to or instead of an acknowledged alert status field.

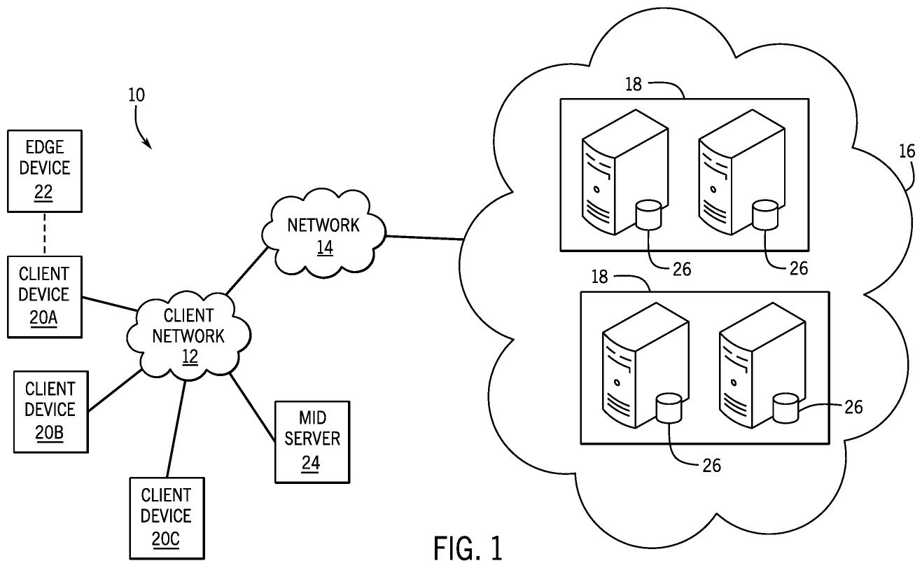

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

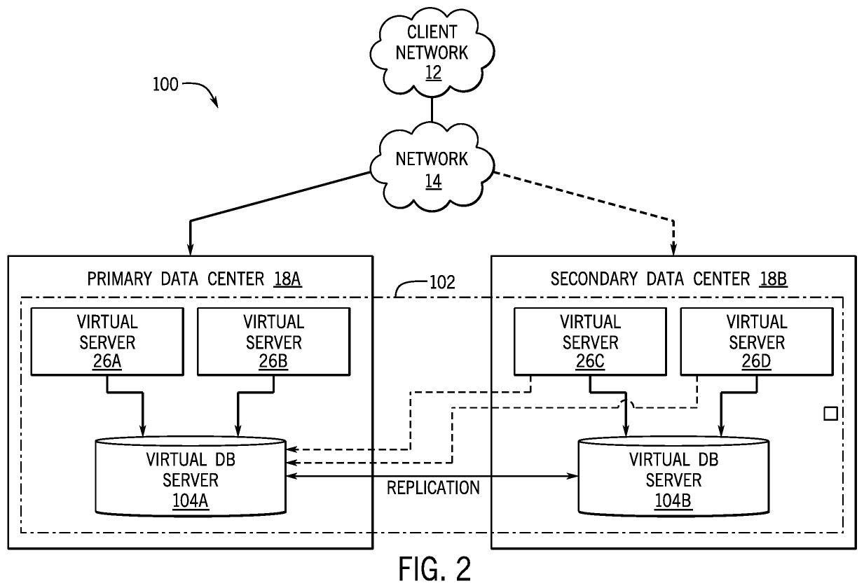

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

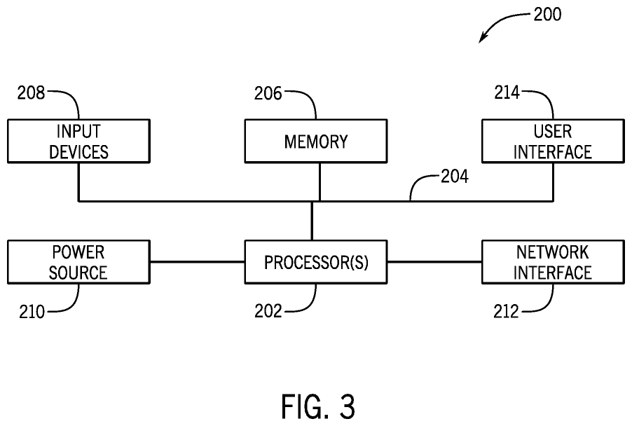

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

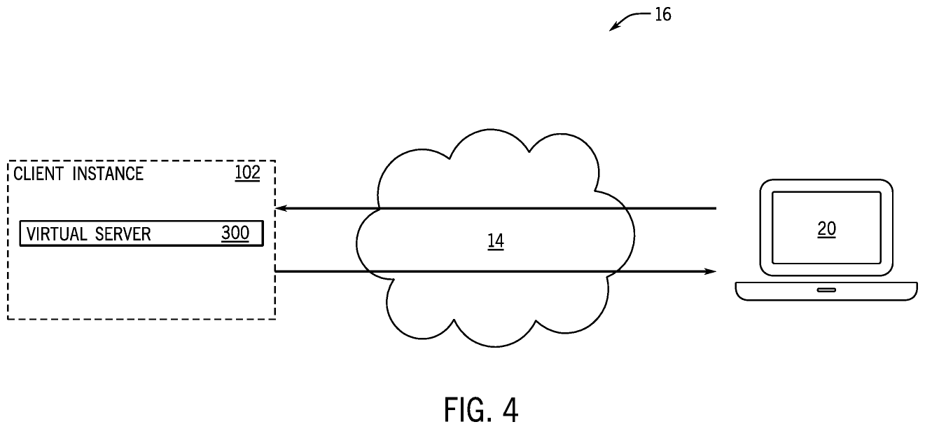

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As may be appreciated, the preceding platform and system level discussions provide examples of an IT architecture and associated devices which may be managed by an IT operations management or event management system or application. Such a system or application may itself run on such a cloud or networked platform, or on an administrative instance supported on such a platform, to support customer operations.

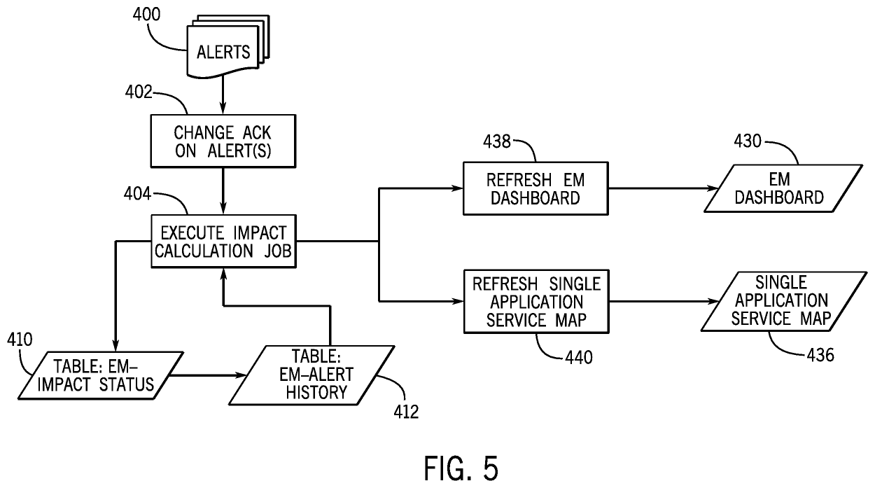

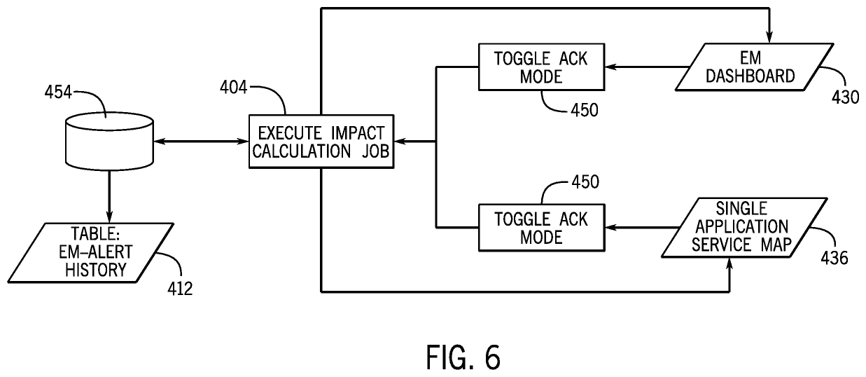

With the preceding in mind, FIGS. 5 and 6 each depict a respective process flow related to use of an acknowledgment field, as presently disclosed, with respect to alerts (or other events) and how such a field may be utilized in event management. Turning to FIG. 5, in this example of a process flow, one or more alerts 400 (e.g., incidents, problems, reported events, and so forth) are present, such as in an event management queue or other management context. In accordance with the present approach, one or more of the alerts 400 may have a status changed (step 402) or assigned to reflect that the respective alert has been “acknowledged” (ACK). In this context, such an “acknowledged” status may indicate that the respective event or alert 400 has been reviewed or addressed, or is pending some completion action, such that there is no current action to take, but the alert or event cannot be indicated as closed until the pending action is performed. By way of example, the pending action may be an action outside the scope of the NOC operator or the organization with which the NOC operator is affiliated, such as the delivery of a replacement part, coding of an update or patch by a software or hardware vendor, and so forth. In practice, the “acknowledged” status may be a selectable status in an existing database field used to track events or may be a status in a separate or new field (e.g., an “acknowledged” field) of such a database, in which case the status may be a selectable status from one or more statuses or may simply be a binary true/false type value for the field.

As shown in FIG. 5, upon one or more alerts 400 having their respective status set to “acknowledged” an impact calculation job or routine may be executed (step 404) that determines or updates the assessed or quantified or impact of alerts or other events within a queue (e.g., pending alerts). That is, the “acknowledged” state of one or more alerts 400 may be a factor in determining a calculated impact of one or more of the alerts 400. In this example, this may result in one or more fields of a table (such as an event management (EM) Impact Status table 410) of a database (e.g., an EM database) being updated, such as to include the relevant “acknowledgement” status change(s) and/or update calculated impacts. Further, per this example, one or more fields of an EM Alert History table 412 or similar table may be updated to capture a history of status or impact changes in the EM Alert table 410.

In addition, as shown in the example process flow of FIG. 5, based on the execution (step 404) of the impact calculation routine(s), one or both of an EM dashboard 430 or a single application service map 436 may be refreshed (steps 438 and 440 respectively). Such graphical tools may be used by a NOC operator in addressing alerts 400 based on severity, pending, time, and so forth.

With the preceding in mind, and turning to FIG. 6, a further aspect of the present approach is illustrated. In this example, an action is illustrated by which a NOC operator or other user may toggle (step 450) (such as by interacting with a displayed control feature on an EM dashboard 430 or service map 436) whether alerts 400 that have an acknowledged status are displayed or not. That is, the user may toggle between a first mode in which acknowledged alerts are displayed and a second mode in which acknowledged alerts are not displayed. In this manner, critical or urgent alerts that are acknowledged, but not closed, may be removed from view so as to allow remaining alerts to be more readily viewed or displayed. In the depicted example, toggling between displaying or not displaying the acknowledged alerts may cause the impact calculation routine(s) to be executed (step 404), causing a re-ranking of alerts 400, with the appropriate alerts then being displayed for review by updating the EM dashboard 430 and/or service map 436. In addition, in this example execution of the impact calculation routines may cause an EM Alert History table 412 of an EM database 454 to be updated to reflect the results of the impact calculation.

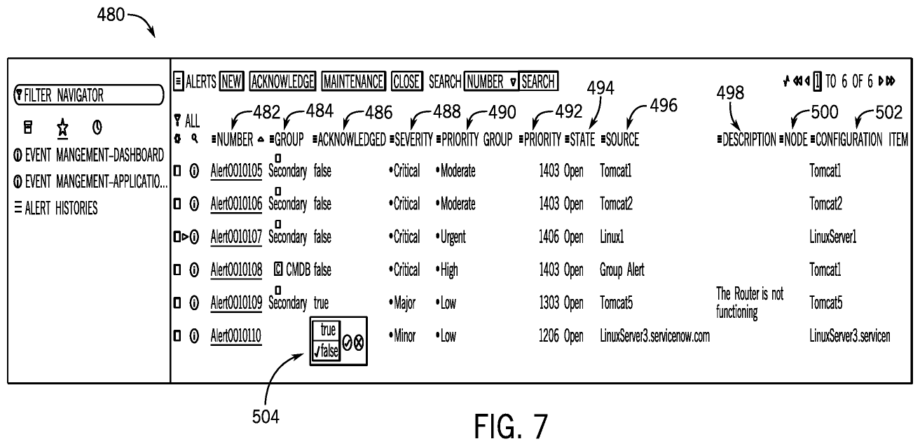

By way of further example, and turning to FIG. 7, a sample of a screen 480 is depicted that displays fields that may be present in an EM Alerts table as discussed herein. The screen 480 depicts an interface in the form of a list view by which a user (e.g., a NOC operator) may view and interact with records associated with different alerts 400 and the fields associated with each record. In this example, the example of a user interface displays in a tabular form fields for: alert records (field 482) where each alert record corresponds to a different tracked alerts or events, group identifiers (field 484) corresponding to different categories or classifications that alert records may be grouped by, an acknowledged status (field 486) corresponding to a status of a given alert as acknowledged (i.e., true) or unacknowledged (i.e., false), a severity classification (field 488) corresponding to a determined severity or criticality of a given alert, a priority assignment (field 490) corresponding to a classification for each alert into a respective priority bin or group, a numerical priority value (field 492) corresponding to a calculated or quantified measure of priority for a given alert, a state of the alert (field 494) corresponding to a state or status (e.g., open, pending, closed, and so forth) of a given alert, a source of each alert (field 496), a description of each alert (field 498), a node associated with each alert (field 500) that may correspond to a location on a service, device, or network map, and a configuration item associated with each alert (field 502) which in a CMDB context may correspond to a configuration item tracked in the CMDB with which each alert is associated. As shown in the present example, the acknowledged state of each alert record is tracked separate from the state of the alert record, allowing these values to be manipulated independent of one another (i.e., alert records having different alert states (pending open, and so forth) may be independently flagged as acknowledged or not acknowledged. In the present interface example, an interaction feature 504 is also illustrated that may be invoked by a user viewing the interface to allow changes to be made to a field or record displayed in the interface. In this example, the interaction feature has been invoked and is displayed with respect to the “acknowledged” field 486, allowing a user to select from the options for that field, i.e., true (acknowledged) or false (not acknowledged) for the selected record. In this manner, the user may use the interface 480 to assign or change the acknowledged status of a given alert record.

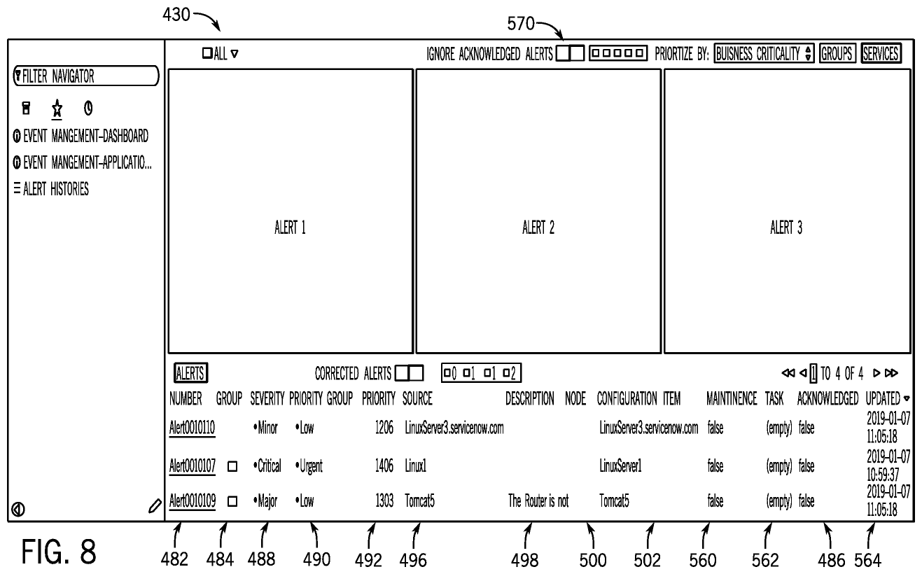

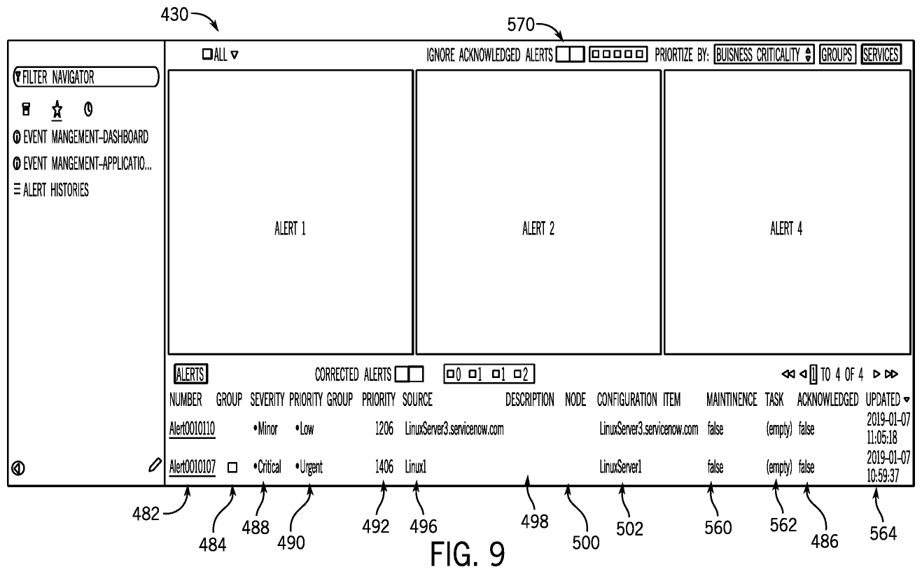

While FIG. 7 illustrates one interface by which a user might change a status of an alert record between “acknowledged” and “not acknowledged” states, FIGS. 8 and 9 illustrate further aspects of the present approach in which a user (e.g., a NOC operator) may refine a presentation of alerts based on whether an alert has been indicated as acknowledged or not.

In this example, an EM dashboard 430 is illustrated which includes a graphical display of alerts 400 (here shown as Alert 1, Alert 2, and Alert 3) deemed to be of the highest importance for a user to review or address. In addition, a list view at the bottom of the depicted example lists alerts of interest along with certain of the fields discussed with respect to FIG. 7 that may be present in an EM Alerts tables as discussed herein. In addition, for each alert record 482, additional fields are illustrated in this view, including a maintenance field 560, a task field 562, and an updated date/time field 564.

In addition, and as shown in FIG. 8 a control feature 570 (e.g., a virtual toggle, button, and so forth) is illustrated with which a user may interact. In the depicted example, the state of the control feature 570 determines whether acknowledged alerts (i.e., alert records 482 having a “acknowledged” status) are taken into consideration in populating the EM dashboard 430. In the example of FIG. 8 the control feature 570 is set to include acknowledged alerts in populating the displayed dashboard. As noted herein, in this state, alerts that have been acknowledged but that are not closed (e.g., alerts for which no action can be currently taken pending some other action or event occurring) are displayed on the EM dashboard 430, potentially obscuring or having a higher prioritization in the display than events that are not acknowledged, and for which an action might be taken. Thus, this view might provide a ranked or prioritized view of alerts that are unresolved or still open, but may include such alerts or events even though no action can be currently taken.

Turning to FIG. 9, in this example the control feature 570 has been interacted with to cause acknowledged alerts to be ignored or otherwise hidden from view, i.e., the dashboard view is set to ignore acknowledged alerts. As discuss herein, in response to the mode being toggled to ignore acknowledged alerts, one or more alert impact calculation routines may be executed or re-executed and, in response to the update impact calculations, the EM dashboard 430 may be updated to show the most impactful alerts that do not include the acknowledged alerts. In this manner, alerts that may benefit from attention but which may not have been visible due to the presence of higher priority, but acknowledged alerts, are now readily visible.

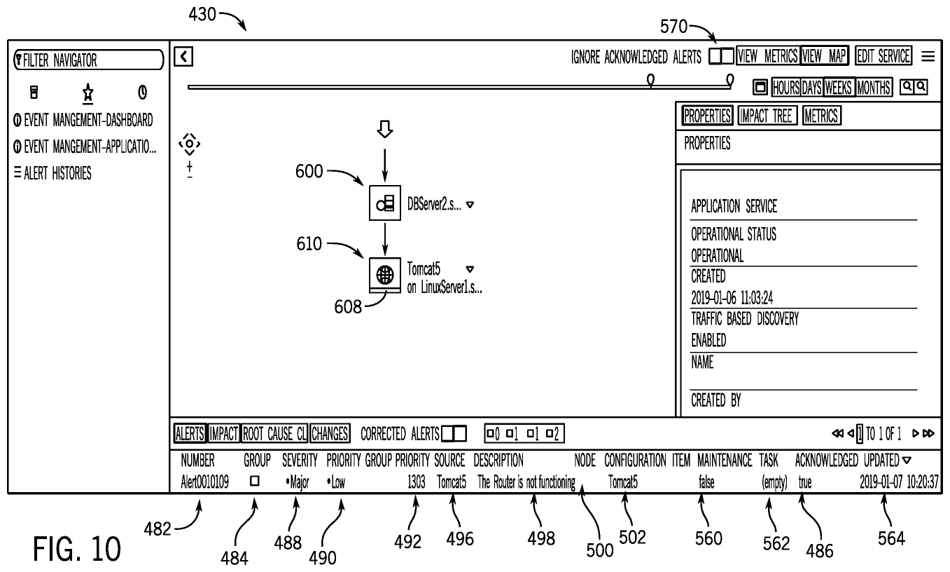

Turning to FIG. 10, further aspects of this approach shown in the context of a node-based map 600 (e.g., a service map, device map, network map, and so forth) displayed as part of the EM dashboard 430. In this example, the control feature 570 is not set so as to cause acknowledged alerts to be ignored. Correspondingly, on the map 600 an alert indication 608 (here an indicator bar) is provided on a service 610 for which there is an acknowledged alert.

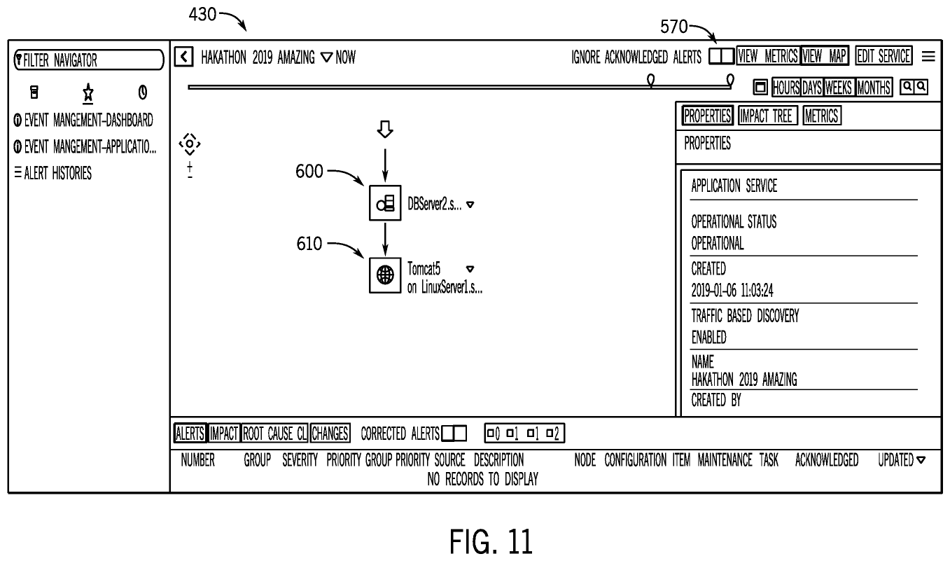

Turning to FIG. 11, the control feature 570 has been activated or otherwise manipulated to a mode corresponding to a mode in which acknowledged alerts are ignored or otherwise hidden from view. As discussed herein, in response to the mode being toggled to ignore acknowledged alerts, one or more alert impact calculation routines may be executed or re-executed and, in response to the update impact calculations, the map 600 may be updated to remove indications of the acknowledged alerts. In this manner, alerts that have been acknowledged, and for which no action may currently be performed to further address the alert, may be obscured or removed so that a user (e.g., a NOC operator) may focus on unacknowledged alerts.

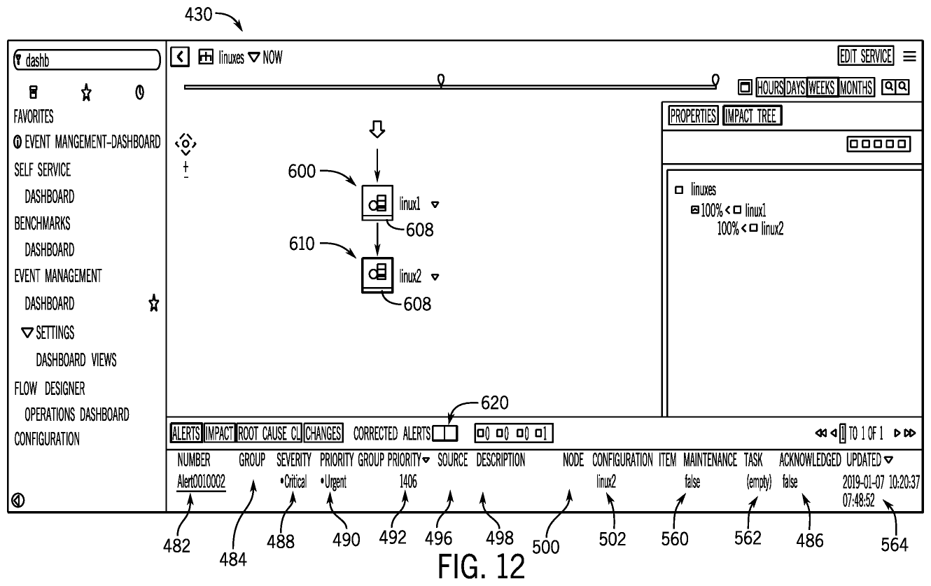

In a further example, and turning to FIG. 12, an impact tee view in instead provided in which the effects of an alert or event can be viewed up and/or down a tree of connected nodes (e.g., services or devices). In this example, a correlated alerts control feature 620 is shown as being provided that allows the capability to show or hide alerts in the same alert group. Based on this control feature, when correlated alerts are selected to be shown, services affected by a given alert are illustrated as affected. As in the preceding example, when acknowledge alerts are instead ignored, based on a suitable control selection, acknowledged alerts may be hidden from view instead so as to allow unacknowledged alerts to be more clearly visible.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method for event management, comprising:
storing a plurality of alert records in a first table of a configuration management database (CMDB), wherein each alert record of the plurality of alert records comprises an acknowledged field separate from a status field, and wherein each alert record of the plurality of alert records is associated with a configuration item represented in the CMDB;
displaying one or more alert records of the plurality of alert records on an interface;
receiving an input via the interface that indicates a first alert record of the one or more alert records is acknowledged but not closed; and
in response to the input, saving a value of a respective acknowledged field of the first alert record in the CMDB to indicate an alert associated with the first alert record has been acknowledged.

2. The method of claim 1, wherein the respective acknowledged field of the first alert record does not indicate that the alert is closed.

3. The method of claim 1, wherein no current action is available to close the alert.

4. The method of claim 1, further comprising:
executing an impact calculation subsequent to saving the value of the respective acknowledged field of the first alert record to indicate that the alert has been acknowledged for each of the one or more alert records.

5. The method of claim 4, further comprising:
updating at least one alert record of the plurality of alert records in the first table based on the impact calculation.

6. The method of claim 4, further comprising:
updating one or more records of an alert history table associated with the plurality of alert records in the CMDB based on the impact calculation.

7. The method of claim 1, further comprising:
refreshing a dashboard of the interface on which one or both of lists or graphics related to the plurality of alert records are prioritized and displayed, wherein in a first mode acknowledged alerts are included on the dashboard and in a second mode acknowledged alerts are excluded from the dashboard.

8. The method of claim 1, further comprising:
refreshing a map on which services or devices affected by alerts are displayed, wherein in a first mode acknowledged alerts are included on the map and in a second mode acknowledged alerts are not shown on the map.

9. A method for viewing alerts, comprising:
receiving an input via a control feature of a user interface displayed on a screen, wherein the input indicates a selection of a first mode of displaying a dashboard of the user interface;
determining, for a plurality of alert records stored in a configuration management database (CMDB), which alert records of the plurality of alert records are not closed but have an acknowledged status in an acknowledged field separate from a status field, wherein each alert record is associated with a configuration item (CI) represented in the CMDB; and
updating a display of the dashboard while in the first mode to not display alerts on the dashboard corresponding to alert records in the CMDB associated an acknowledged status in the respective acknowledged field.

10. The method of claim 9, further comprising:
executing an impact calculation in response to the input; and
updating the CMDB based on an output of the impact calculation.

11. The method of claim 9, further comprising:
receiving an additional input via the control feature, wherein the additional input indicates a selection of a second mode of displaying the dashboard; and
updating the display of the dashboard while in the second mode to display alerts having an acknowledged status on the dashboard.

12. The method of claim 9, wherein the dashboard displays one or more of one or more lists of alerts, graphical representations of alerts, or a map representation.

13. The method of claim 12, wherein the map representation comprises one of a service map, a network map, or a device map.

14. The method of claim 12, wherein updating the display of the map representation results in nodes associated with a respective acknowledged alert being displayed without a visual indication of the respective alert.

15. The method of claim 9, wherein updating the display of the dashboard results in alerts not having a respective acknowledged status and previously not displayed on the dashboard being currently displayed on the dashboard.

16. An event management system, comprising:
one or more processing components;
one or more memory or storage components encoding routines which, when executed by the one or more processing components cause the one or more processing components to perform operations comprising:
accessing a configuration management database (CMDB) comprising at least a first table comprising a plurality of alert records, wherein each alert record of the plurality of alert records comprises an acknowledged field separate from a status field and wherein each acknowledged field comprises either an acknowledged status or a not acknowledged status, and wherein each alert record of the plurality of alert records is associated with a configuration item represented in the CMDB;
displaying a user interface having a control feature configured to allow selection between a first mode and a second mode of displaying a dashboard;
receiving an input from the control feature that indicates a selection of the first mode; and
in response to the input, updating a display of the dashboard to not display alerts having an acknowledged but pending status.

17. The event management system of claim 16, wherein the operations further comprise:
displaying one or more of the alert records; and
in response to a change acknowledged status input, changing a value of a respective acknowledged field of a first alert record to indicate an alert associated with the first alert record has been acknowledged.

18. The event management system of claim 17, wherein the operations further comprise:
updating the display of the dashboard to not display alerts for which the acknowledged status has been changed to acknowledged from not acknowledged.

19. The event management system of claim 16, wherein the operations further comprise:
in response to an alternative input from the control feature indicating a selection of the second mode, updating the display of the dashboard to display alerts having an acknowledged status.

20. The event management system of claim 16, wherein the dashboard displays one or more of one or more lists of alerts, graphical representations of alerts, or a map representation.
